(19) United States
(12) Patent Application Publication
(10) Pub. No.: US 2005/0048460 A1
(43) Pub. Date: Mar. 3, 2005

(54) Preservative and method for preserving cells

(75) Inventors: John H. Crowe, Davis, CA (US); Fern Tablin, Davis, CA (US); Ann E. Oliver, Sacramento, CA (US); Kamran Jamil, Porterville, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California, Oakland, CA (US)

(21) Appl. No.: 10/853,062

(22) Filed: May 24, 2004

Related U.S. Application Data
(63) Continuation-in-part of application No. 10/722,154, filed on Nov. 25, 2003.
(60) Provisional application No. 60/474,278, filed on May 29, 2003.
(60) Provisional application No. 60/528,563, filed on Dec. 10, 2003.

(51) Int. Cl. A01N 1/02

(52) U.S. Cl. 435/2

(57) ABSTRACT

A method for stabilizing a biological material (e.g., blood platelets, cells, etc.) comprising treating a biological material with an amphiphilic agent (e.g., an amphiphilic compound, such as a surfactant, or pluronic or arbutin) to stabilize the biological material. At least one carbohydrate (e.g., trehalose or a trehalose-sucrose mixture) may be combined with the amphiphilic agent for treating the biological material. The treated biological material may be dehydrated. A biological material produced in accordance with the method for treating the biological material.

### RELATED PATENT APPLICATIONS

This application claims the benefit of U.S. Provisional Application No. 60/474,278, filed May 29, 2003, and fully incorporated herein by reference thereto. This application also claims the benefit of U.S. Provisional Application No. 60/528,563, filed Dec. 10, 2003, and fully incorporated herein by reference thereto. This application is also a continuation-in-part application of co-pending application Ser. No. 10/722,154, filed Nov. 25, 2003, and fully incorporated herein by reference thereto.

This patent application is related to co-pending patent application Ser. No. 10/052,162, filed Jan. 16, 2002. Patent application Ser. No. 10/052,162 is a continuation-in-part patent application of co-pending patent application Ser. No. 09/927,760, filed Aug. 9, 2001. Patent application Ser. No. 09/927,760 is a continuation-in-part patent application of co-pending patent application Ser. No. 09/828,627, filed Apr. 5, 2001. Patent application Ser. No. 09/828,627 is a continuation patent application of patent application Ser. No. 09/501,773, filed Feb. 10, 2000. Benefit of all of the foregoing patent applications is claimed, and all of the foregoing patent applications are fully incorporated herein by reference thereto as if repeated verbatim immediately hereinafter.

### STATEMENT REGARDING FEDERAL SPONSORED RESEARCH AND DEVELOPMENT

Embodiments of this invention were made with Government support under Grant No. N66001-02-C-8055, awarded by the Department of Defense Advanced Research Projects Agency (DARPA). The Government has certain rights to embodiments of this invention.

### FIELD OF THE INVENTION

Embodiments of the present invention generally broadly relate to living mammalian cells including blood platelets. More specifically, embodiments of the present invention generally provide for the preservation and survival of blood platelets and cells, especially human cells.

Embodiments of the present invention also generally broadly relate to the therapeutic uses of platelets and cells; and more particularly to manipulations or modifications of platelets and cells, such as loading platelets and cells with solutes and in preparing dried compositions (e.g., freeze-dried, vacuum dried, air dried, etc.) that can be re-hydrated at the time of application. When platelets and cells for various embodiments of the present invention are re-hydrated, they are immediately restored to viability.

The compositions and methods for embodiments of the present invention are useful in many applications, such as in medicine, pharmaceuticals, biotechnology, and agriculture, and including transfusion therapy, as hemostasis aids and for drug delivery.

### BACKGROUND OF THE INVENTION

A biological sample includes cells and blood platelets. A cell is typically broadly regarded in the art as a small, typically microscopic, mass of protoplasm bounded externally by a semi-permeable membrane, usually including one or more nuclei and various other organelles with their products. A cell is capable either alone or interacting with other cells of performing all the fundamental function(s) of life, and forming the smallest structural unit of living matter capable of functioning independently.

Blood platelets, or thrombocytes, are cells formed from megakaryocytes in bone marrow. Platelets enter the blood circulation system by fragmentation of the megakaryocytes and survive in the blood circulation system for a number of days. Thus, blood platelets are a fraction of human blood and are involved in the blood coagulation process by being important contributors to hemostasis by causing the promotion of vasoconstriction and platelet aggregation, all of which stimulate blood coagulation and an arresting of bleeding in damaged blood vessels.

It is known that blood platelets are generally oval to spherical in shape and have a diameter of 2-4 μm, and comprise about 60% protein, about 15% lipid, and about 8.5% carbohydrate. Included in the chemical composition of blood platelets are serotonin, epinephrine, and nor-epinephrine, each of which aids in promoting the constriction of blood vessels at a site of injury. Blood platelets also contain platelet factors, including platelet thromboplastin, which is a cephalin-type phosphastide, and adenosine diphosphate, both of which are important in blood coagulation. The maintenance of functional platelets is important in preserving whole blood for storage in blood banks, and in preserving concentrated platelet fractions.

Blood banks are under considerable pressure to produce platelet concentrates for transfusion. The enormous quest for platelets necessitates storage of this blood component, since as indicated platelets are important contributors to hemostasis. Today platelet rich plasma concentrates are stored in blood bags at 22°-24° C.; however, the shelf life under these conditions is limited to five days. The rapid loss of platelet function during storage and risk of bacterial contamination complicates distribution and availability of platelet concentrates. Platelets tend to become activated at low temperatures. When activated they are substantially useless for an application, such as transfusion therapy.

Cells and platelets may be transported and transplanted; however, this requires cryopreservation which includes freezing and subsequent reconstitution (e.g., thawing, re-hydration, etc.) after transportation. Unfortunately, a very low percentage of platelets and cells retain their functionality after undergoing freezing and thawing. While some cryoprotectants, such as dimethyl sulfoxide, tend to lessen the damage to platelets and cells, they still do not prevent some loss of platelet and cell functionality.

Trehalose has been found to be suitable in the cryopreservation of cells and platelets. Trehalose is a disaccharide found at high concentrations in a wide variety of organisms that are capable of surviving almost complete dehydration. Trehalose has been shown to stabilize membranes, proteins, and certain cells during freezing and drying in vitro.

Spargo et al., U.S. Pat. No. 5,736,313, issued Apr. 7, 1998, have described a method in which platelets are loaded overnight with an agent, preferably glucose, and subsequently lyophilized. The platelets are preincubated in a buffer and then are loaded with carbohydrate, preferably glucose, having a concentration in the range of about 100 mM to about 1.5 M. The incubation is taught to be conducted at about 10° C. to about 37° C., most preferably about 25° C.

U.S. Pat. No. 5,827,741, Beattie et al., issued Oct. 27, 1998, discloses cryoprotectants for human cells and platelets, such as dimethylsulfoxide and trehalose. The cells or platelets may be suspended, for example, in a solution containing a cryoprotectant at a temperature of about 22° C. and then cooled to below 15° C. This incorporates some cryoprotectant into the cells or platelets, but not enough to prevent hemolysis of a large percentage of the cells or platelets.

Accordingly, a need exists for the effective and efficient preservation of platelets and cells. More specifically, and accordingly further, a need also exists for the effective and efficient preservation of platelets and cells (e.g., erythrocytic cells, eukaryotic cells, or any other cells, and the like) and for efficient recovery of dried platelets and cells, such that the preserved platelets and cells respectively maintain their biological properties and may readily become viable after storage.

### SUMMARY OF EMBODIMENTS OF THE INVENTION

In one aspect of the present invention, a solute solution is provided for protecting platelets and cells, particularly during recovery of dehydrated platelets and cells. In an embodiment of the invention, biological materials are treated with an amphiphilic agent (e.g., a surfactant, pluronic or arbutin, etc.) to stabilize the biological materials, particularly for dehydration purposes.

In another embodiment of the invention, the solute solution comprises arbutin and a carbohydrate, such as an oligosaccharide. The oligosaccharide may be a disaccharide, such as trehalose and/or sucrose. In another embodiment of the invention, the solute solution comprises arbutin and a mixture of oligosaccharides, such as a mixture of disaccharides (e.g., trehalose and sucrose).

In a further aspect of the present invention, a method is provided for protecting platelets or cells. Embodiments of the invention include treating platelets or cells with any embodiments of the solute solution for the present invention. The platelets or cells are disposed in the solute solution having a solute concentration of sufficient magnitude for transferring (e.g., via fluid phase endocytosis) a solute (e.g., arbutin and trehalose; or arbutin, trehalose and sucrose) from the solute solution into the platelets or cells.

Embodiments of the present invention include a solution for treating a biological material comprising an amphiphilic agent and a carbohydrate. The solution may comprise one of the following mixing proportions: (i) from about 1.0% by wt. to about 40% by weight of the carbohydrate, and from about 0.01 to about 40% by weight of the amphiphilic agent; (ii) from about 2.0% by wt. to about 12% by weight of the carbohydrate, and from about 0.1 to about 20% by weight of the amphiphilic agent; (iii) from about 4.0% by wt. to about 8% by weight of the carbohydrate, and from about 0.5 to about 10% by weight of the amphiphilic agent; (iv) from about 4.0% by wt. to about 6% by wt. (e.g., about 5.7% by wt.) of the carbohydrate, and from about 1.0% by wt. to about 5.0% by wt. (e.g., about 2% by wt.) of the amphiphilic agent; (v) from about 0.01% by wt. to about 60% by weight of the carbohydrate, and from about 0.01 to about 30% by weight of the amphiphilic agent; (vi) from about 0.02% by wt. to about 40% by weight of the carbohydrate, and from about 0.01 to about 20% by weight of the amphiphilic agent; (vii) from about 0.20% by wt. to about 20% by weight of the carbohydrate, and from about 0.10 to about 10% by weight of the amphiphilic agent; (viii) from about 1.5% by wt. to about 6% by weight of the carbohydrate (e.g., about 0.8% by wt. trehalose and about 1.0% by wt. sucrose), and from about 1 to about 5% by weight of the amphiphilic agent (e.g., about 1.6% by wt. arbutin).

Embodiments of the present invention provide a process for loading a biological sample comprising loading a biological sample with an amphiphilic agent and a solute (e.g., trehalose) by fluid phase endocytosis to produce an internally loaded biological sample. The loading of a biological sample by fluid phase endocytosis comprises fusing within the biological sample a first matter (e.g., a vesicle) with a second matter (a lysosome) to produce a fused matter. The fused matter preferably comprises the amphiphilic agent and the solute. The loading of a biological sample by fluid phase endocytosis additionally comprises transferring the solute and the amphiphilic agent from the fused matter into a cytoplasm within the biological sample. The fused matter may comprise a lower pH than a pH of the first matter. The fused matter preferably comprises a pH of less than about 6.5, such as from about 3.0 to about 6.0. The biological sample may include a biological sample selected from a group of biological samples comprising a platelet and a cell.

Embodiments of the present invention also further provide a process for preparing a dehydrated biological sample comprising providing a biological sample selected from a mammalian species, loading the biological sample with a solute and an amphiphilic agent by fluid phase endocytosis to produce a loaded biological sample, and drying (e.g., vacuum drying, air drying, freeze-drying, etc.) the loaded biological sample to produce a dehydrated biological sample.

These provisions, together with the various ancillary provisions and features which will become apparent to those skilled in the art as the following description proceeds, are attained by the processes and cells of the present invention, preferred embodiments thereof being shown with reference to the accompanying drawings, by way of example only, wherein:

### BRIEF DESCRIPTION OF THE DRAWINGS

In the drawings:

FIG. 1 is an exemplary diagram of a biological sample having a plasma membrane with an internal protein coating and encapsulating a cytoplasm having lysosomes and a nucleus.

FIG. 2 is an elevational view of the plasma membrane in contact with a solute solution having a solute which is to be loaded into the biological sample.

FIG. 3 is an elevational view of the plasma membrane in the process of being loaded with a solute.

FIG. 4 is an elevational view of a vesicle containing a solute and connected to the plasma membrane.

FIG. 5 is a diagram of the cytoplasm having a lysosome and a vesicle containing a solute and which “budded off” or released from the plasma membrane.

FIG. 6 is a diagram of a lysosome fused with a vesicle to produce fused matter or material containing a solute.

FIG. 7 is a diagram of the fused matter or material containing a solute which is in the process of passing in direction of the arrow from the fused matter or material into the cytoplasm of the biological sample to effectively load the biological sample with the solute.

FIG. 8 is an enlarged chemical structural, chain formula diagram of trehalose, a non-reducing disaccharide of glucose, with an arrow pointing to a glycosidic bond.

FIG. 9 is an enlarged chemical structural, chain formula diagram of sucrose, a non-reducing disaccharide of glucose and fructose, with an arrow pointing to a glycosidic bond which is much more susceptible to hydrolysis than the glycosidic bond in trehalose.

FIG. 10 is a graph of solute concentration vs. % retention CF for the solute trehalose, for the solute arbutin, and for SAT (the solutes sucrose and trehalose plus arbutin at a 3:2:1 mass ratio).

FIG. 11 is a picture of MSCs which were treated with arbutin and trehalose.

FIG. 12 is a picture of MSCs which were treated with arbutin and trehalose.

FIG. 13 is a picture of MSCs which were treated with only trehalose, and not arbutin.

FIG. 14 is a graph of number of colonies formed in the samples not treated with arbutin and in the samples treated with arbutin.

FIG. 15 is a graph of viability (%) of 293H cells vs. external arbutin concentration in the loading solute solution.

FIG. 16 is a graph of total live cells of MSCs vs. external arbutin concentration in the loading solute solution.

FIG. 17 is a graph of survival (% control) after freeze-drying vs. g H₂O/g dry wt. for MSCs and 293H cells.

FIG. 18 is a graph of % viability vs. external trehalose concentration (mM), and internal trehalose conc. (mM) vs. external trehalose concentration (mM), for trehalose loading by fluid phase endocytosis.

FIG. 19 a graph of water content vs. % viability for vacuum-drying of MSC in the presence and the absence of arbutin.

FIG. 20 is a graph of the fluorescence of alamarBlue as a function of the water content when MSC cells were vacuum-dried with and without arbutin.

FIG. 21 is a graph illustrating line plots indicating the total number of cells in [for fields of view for] each sample (square for arbutin-containing samples, and triangle for controls), and a histogram indicating the percentage of those cells that were positively stained for BrdU.

### DETAILED DESCRIPTION OF PREFERRED EMBODIMENTS OF THE INVENTION

Embodiments of the present invention broadly include biological samples, preferably mammalian biological samples. Embodiments of the present invention further broadly include methods for preserving biological samples, as well as biological samples that have been manipulated (e.g., by drying, such as by vacuum drying, to produce dehydrated biological samples) or modified (e.g., loaded with a chemical or drug) in accordance with methods of the present invention. Embodiments of the present invention also further broadly include methods for increasing the survival of biological samples, especially during drying and following drying, storing and rehydrating.

Biological samples for various embodiments of the present invention comprise any suitable biological sample, such as blood platelets and cells. The cells may be any type of cell including, not by way of limitation, erythrocytic cells, eukaryotic cells or any other cell, whether nucleated or non-nucleated.

The term “erythrocytic cell” is used to mean any red blood cell. Mammalian, particularly human, erythrocytes are preferred. Suitable mammalian species for providing erythrocytic cells include by way of example only, not only human, but also equine, canine, feline, or endangered species.

The term “eukaryotic cell” is used to mean any nucleated cell, i.e., a cell that possesses a nucleus surrounded by a nuclear membrane, as well as any cell that is derived by terminal differentiation from a nucleated cell, even though the derived cell is not nucleated. Examples of the latter are terminally differentiated human red blood cells. Mammalian, and particularly human, eukaryotes are preferred. Suitable mammalian species include by way of example only, not only human, but also equine, canine, feline, or endangered species.

The source of the eukaryotic cells may be any suitable source such that the eukaryotic cells may be cultivated in accordance with well known procedures, such as incubating the eukaryotic cells with a suitable serum (e.g., fetal bovine serum). After the eukaryotic cells are cultured, they are subsequently harvested by any conventional procedure, such as by trypsinization, in order to be loaded with a protective preservative. The eukaryotic cells are preferably loaded by growing the eukaryotic cells in a liquid tissue culture medium. The preservative (e.g., an oligosaccharide, such as trehalose) is preferably dissolved in the liquid tissue culture medium, which includes any liquid solution capable of preserving living cells and tissue. Many types of mammalian tissue culture media are known in the literature and available from commercial suppliers, such as Sigma Chemical Company, St. Louis, Mo., USA: Aldrich Chemical Company, Inc., Milwaukee, Wis., USA; and Gibco BRL Life Technologies, Inc., Grand Island, N.Y., USA. Examples of media that are commercially available are Basal Medium Eagle, CRCM-30 Medium, CMRL Medium-1066, Dulbecco's Modified Eagle's Medium, Fischer's Medium, Glasgow Minimum Essential Medium, Ham's F-10 Medium, Ham's F-12 Medium, High Cell Density Medium, Iscove's Modified Dulbecco's Medium, Leibovitz's L-15 Medium, McCoy's 5A Medium (modified), Medium 199, Minimum Essential Medium Eagle, Alpha Minimum Essential Medium, Earle's Minimum Essential Medium, Medium NCTC 109, Medium NCTC 135, RPMMI-1640 Medium, William's Medium E, Waymouth's MB 752/1 Medium, and Waymouth's MB 705/1 Medium.

Molarity, or millimolarity, mM, is the number of moles (or millimoles) of a solute per liter of solution and is a measure of the concentration. Osmolarity (Osm), or milliosmolarity (mOsm), is a count of the number of dissolved particles per liter of solution and is a measure of the osmotic pressure exerted by solutes. Biological membranes, such as platelet or cell membranes, can be semi-permeable because they allow water and some small molecules to pass, but block the passage of proteins or macromolecules. Since the osmolarity of a solution is equal to the molarity times the number of particles per molecule, 600 mM trehalose is equal to 600 mOsm trehalose because trehalose does not dissociate in water. However, with respect to compounds that dissociate in water, such as NaCl, 1 mM NaCl is equal to 2 mOsm NaCl because it has two particles. Similarly, 100 mM NaCl is equal to 200 mOsm NaCl. Thus, for a 300 mOsm PBS buffer (100 mM NaCl, 9.4 mM Na₂HPO₄, 0.6 mm KH₂PO₄, pH 7.4), 300 mOsm refers to all of the osmotically active particles in the PBS solution, with 200 mOsm of the 300 mOsm stemming from NaCl.

Broadly, the preparation of solute-loaded biological sample(s) (e.g., platelets and cells) in accordance with embodiments of the invention comprises the steps of loading one or more biological samples with a solute by placing the biological samples in a solute solution for transferring (e.g., by fluid phase endocytosis) the solute and an amphiphilic agent from the solution into the biological sample(s). For increasing the transfer or uptake of the solute and the amphiphilic agent from the solute solution, the solute solution temperature, or incubation temperature, may have a temperature above about 25° C., more preferably above 30° C., such as from about 30° C. to about 40° C.

The solute solution for various embodiments of the present invention may be used for loading and/or washing and/or drying (e.g., freeze-drying, air drying, vacuum drying) and/or rehydration, or for any other suitable purpose. When the solute solution is employed for loading a solute into platelets or cells, the solute solution may be any suitable physiologically acceptable solution (e.g., cell growth medium) in an amount and under conditions effective to cause uptake or “introduction” of the solute from the solute solution into the platelets or cells. A physiologically acceptable solution is a suitable solute-loading buffer, such as any of the buffers stated in the previously mentioned related patent applications, all having been incorporated herein by reference thereto. The solute solution may also be any suitable physiologically acceptable solution in an amount and under conditions effective for washing and/or drying and/or rehydration. Therefore, the solute solution may be used as a washing buffer for washing loaded cells and/or as a drying buffer (e.g., freeze-drying, air-drying, vacuum drying, etc) for freeze-drying loaded cells and/or as a rehydration buffer for rehydrating dried cells or reconstituting cells. Thus, any of the solute solutions for embodiments of the present invention may be used for any suitable purpose, including loading, washing, drying (e.g., freeze-drying, air drying, vacuum drying, etc.) and rehydration. The following recipes have been found to be effective for various embodiments of the present invention: (i) HEPES 10 mM, KCl 5 mM, NaCl 105 mM, BSA 5.7% by wt., trehalose 150 mM, and arbutin 70 mM; and (ii) TES 10 mM, 0.1 mM EDTA, and up to 50 mg/ml total of sucrose, arbutin and trehalose in a 3/2/1 mass ratio.

The solute solution for treating a biological material in accordance with various embodiments of the present invention broadly comprises an amphiphilic agent and a solute.

The solute may be a carbohydrate (e.g., an oligosaacharide) selected from the following groups of carbohydrates: a monosaccharide, an oligosaccharide (e.g., bioses, trioses, tetroses, pentoses, hexoses, heptoses, etc), a disaccharide (e.g., lactose, maltose, sucrose, melibiose, trehalose, etc), a trisaccharide (e.g., raffinose, melezitose, etc), or tetrasaccharides (e.g., lupeose, stachyose, etc), and a polysaccharide (e.g., dextrins, starch groups, cellulose groups, etc). More preferably, the solute is a disaccharide, with trehalose and/or sucrose being the preferred, particularly since it has been discovered that trehalose and/or sucrose do/does not degrade or reduce in complexity upon being loaded. Thus, in the practice of various embodiments of the invention, the solute (e.g., trehalose and/or sucrose) and the amphiphilic agent are transferred from a solution into the cells without degradation of the solute.

The amphiphilic agent may be any suitable agent or compound, preferably one comprising molecules having a polar water-soluble group attached to a water-insoluble hydrocarbon chain. The amphiphilic agent comprises a molecule having both hydrophobic and hydrophilic portions and includes, by way of example only, surfactants, including pluronic. The amphiphilic agent may also comprise arbutin.

As indicated, embodiments of the present invention include a solute solution for treating a biological material comprising an amphiphilic agent and a solute, such as a carbohydrate. The solute solution may broadly comprise one of the following mixing proportions: (i) from about 1.0% by wt. to about 40% by weight of the carbohydrate, and from about 0.01 to about 40% by weight of the amphiphilic agent; (ii) from about 2.0% by wt. to about 12% by weight of the carbohydrate, and from about 0.1 to about 20% by weight of the amphiphilic agent; (iii) from about 4.0% by wt. to about 8% by weight of the carbohydrate, and from about 0.5 to about 10% by weight of the amphiphilic agent; (iv) from about 4.0% by wt. to about 6% by wt. (e.g., about 5.7% by wt.) of the carbohydrate, and from about 1.0% by wt. to about 5.0% by wt. (e.g., about 2.0% by wt.) of the amphiphilic agent; (v) from about 0.01% by wt. to about 60% by weight of the carbohydrate, and from about 0.01 to about 30% by weight of the amphiphilic agent; (vi) from about 0.02% by wt. to about 40% by weight of the carbohydrate, and from about 0.01 to about 20% by weight of the amphiphilic agent; (vii) from about 0.20% by wt. to about 20% by weight of the carbohydrate, and from about 0.10 to about 10% by weight of the amphiphilic agent; (viii) from about 1.5% by wt. to about 6% by weight of the carbohydrate (e.g., about 0.8% by wt. trehalose and about 2.4% by wt. sucrose), and from about 1 to about 5% by weight of the amphiphilic agent (e.g., about 1.6% by wt. arbutin).

The solute solution may more specifically comprise one of the following mixing proportions: (i) from about 1.0% by wt. to about 40% by weight of trehalose, and from about 0.01 to about 40% by weight of arbutin; (ii) from about 2.0% by wt. to about 12% by weight of the trehalose, and from about 0.1 to about 20% by weight of arbutin; (iii) from about 4.0% by wt. to about 8% by weight of trehalose, and from about 0.50 to about 10% by weight arbutin; (iv) from about 4.0% by wt. to about 6% by wt. (e.g., about 5.7% by wt.) of trehalose, and from about 1.0% by wt. to about 5.0% by wt. (e.g., about 2% by wt.) of arbutin; (v) from about 0.01% by wt. to about 60% by weight of trehalose and/or sucrose (e.g., from about 0.01% by wt. to about 30% by wt. trehalose and from about 0.01% by wt. to about 30% by wt. sucrose), and from about 0.01 to about 30% by weight of arbutin; (vi) from about 0.02% by wt. to about 40% by weight of trehalose and/or sucrose (e.g., from about 0.01% by wt. to about 20% by wt. trehalose and from about 0.01% by wt. to about 20% by wt. sucrose), and from about 0.01 to about 20% by weight arbutin; (vii) from about 0.20% by wt. to about 20% by weight of trehalose and/or sucrose (e.g., from about 0.1% by wt. to about 10% by wt. trehalose and from about 0.1% by wt. to about 10% by wt. sucrose), and from about 0.10 to about 10% by weight of arbutin; (viii) from about 1.5% by wt. to about 6% by weight of trehalose and/or sucrose (e.g., about 0.8% by wt. trehalose and about 2.4% by wt. sucrose), and from about 1 to about 5% by weight of the amphiphilic agent (e.g., about 1.6% by wt. arbutin).

Loading of the solute and the amphiphilic agent from the solute solution into the biological sample(s) broadly includes producing and/or forming at least a portion of a biological membrane of the microbiological sample(s) to entrap and include a solute and the amphiphilic agent; and fusing, commingling, or otherwise combining in any suitable manner, the produced and/or formed solute-containing/amphiphilic-containing portion of the biological membrane with a lysosome to produce fused matter from which the solute and the amphiphilic agent is transferred into the cytoplasm of the biological membrane (e.g., a cell). Producing and/or forming at least a portion of the biological membrane to include the solute and the amphiphilic agent comprises transferring or passing the solute and the amphiphilic agent from the solute solution against and/or into a portion of the biological membrane for producing and/or forming a vesicle (i.e., an endosomal, phagocytic vesicle) containing the solute and the amphiphilic agent. The vesicle after a period of time, which depends on the residence time of the biological sample in the solute solution, subsequently breaks or severs (i.e., “buds off”) from the biological membrane into the cytoplasm of the biological sample(s) to fuse with lysosome(s).

The fusing or combining of the vesicle with a lysosome is caused by recognition sites on both membranes that promote fusion or the combining. The produced fused matter subsequently breaks down or degrades, with the lysosomal membranes being recycled and reloaded in the Golgi. Most sugars are degraded in the lysosome to monosaccharides, which are then transferred to the cytoplasm for further degradation. It is suggested that the mechanism of transfer includes the magnitude of the internal pH in the lysosomes which leads to leakage across the bilayers. The lysosome(s) has/have a low pH, such as a pH ranging from about from about 3.0 to about 5.0. In addition there is the presence of acidic hydrolases in the lysosomes. The vesicle, especially when the vesicle contains the solute, has a higher pH than the pH of the lysosome(s). The vesicle typically has a pH ranging from about 7.0 to about 8.0. Thus, the internal, engulfed material within the fused matter contains a reduced pH, a pH lower than the pH of the vesicle (e.g., a pH less than about 6.5, such as a pH ranging from about 3.5 to about 6.0).

The reduced pH, an acidic pH, causes the membrane of the produced fused matter to have an increased permeability. Stated alternatively, lowering the pH of the internal, engulfed material through the fusing of lysosome and vesicles produces an acidic engulfed material within the fused matter, which concomitantly raises or increases the permeability of the membrane of the fused matter. With an increase in permeability, the solute (or any low molecular weight molecules) and the amphiphilic agent leak or pass through the membrane of the fused matter and into the cytoplasm.

When the solute is a sugar, most sugars hydrolyze within the fused matter. An exception is trehalose, which escapes degradation due to the stability of its associated glycosidic linkage. The broken down components of the lysosome and the vesicles are released into the cytoplasm for further metabolism. The components of sucrose would include glycose and fructose, which are degraded by the well known glycolytic pathway and the TCA cycle to CO₂ and H₂O. Because trehalose remains intact for effecting the transferring and the loading of the solute into the cytoplasm of the biological sample(s), and does not degrade in conditions found in the lysome-endosome, trehalose is a preferred solute. However, it is to be understood that while trehalose is a preferred solute, the spirit and scope of the present invention includes any solute comprising one or more molecules that survive the environmental conditions within the fused matter. More specifically, the solute for various embodiments of the present invention comprises one or more of any molecule(s) that does not degrade under the transferring or loading conditions, or within the environmental conditions within the fused matter resulting from the fusing of lysosome and the vesicle. After the solute (and the amphiphilic agent) is/are transferred out of the fused matter and into the cytoplasm, stability is conferred on the biological sample for further treatment or processing, such as drying.

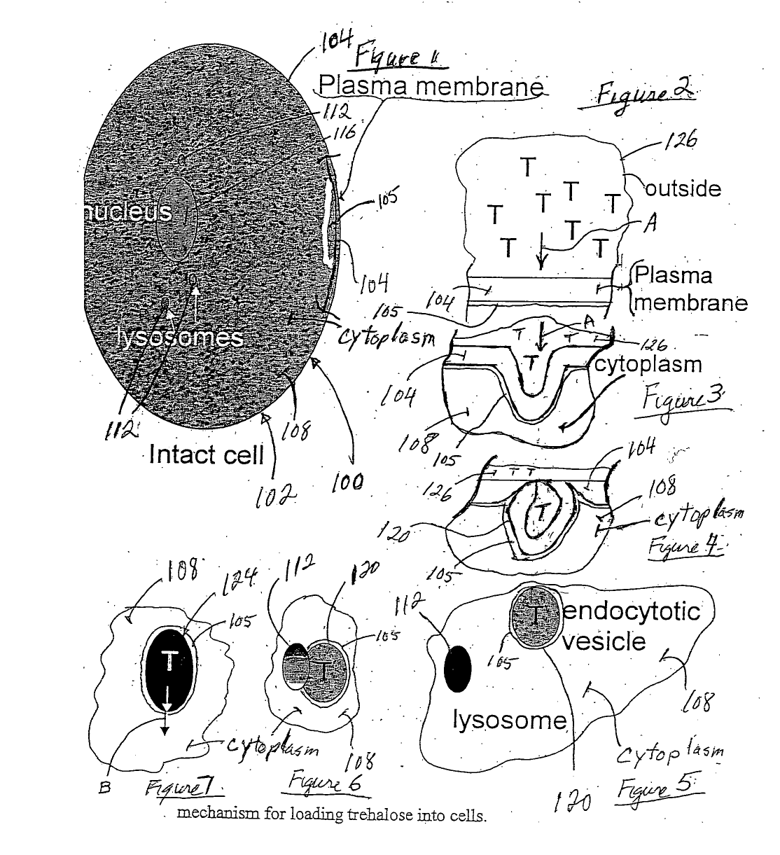

Referring now to FIGS. 1-7 for more specifically describing an embodiment of a mechanism for loading by fluid phase endocytosis a solute and an amphiphilic agent from a solute solution into a biological sample (e.g., platelet(s), cell(s), etc.), there is seen in FIG. 1 a biological sample 100 which is exemplarily represented as an intact cell 102 having a plasma membrane 104 internally coated with a protein (e.g., clathrin) 105. The plasma membrane 104 encapsulates cytoplasm 108 having lysosomes 112. The plasma membrane 104 may also encapsulate a nucleus 116 contained within the cytoplasm 108. The biological sample 100 is disposed in a solute solution 126 having a solute T (e.g., trehalose) and an amphiphilic agent. As shown in FIG. 2, the solute T and the amphiphilic agent is transferred or passed in direction of the arrow A from the solute solution 126 against and/or into a portion of the membrane 104. As previously indicated, the solute solution 126 may be heated to an elevated temperature (e.g., a temperature from about 30° C. to about 40° C.) to assist in transferring the solute T and the amphiphilic agent out of the solute solution 126 and against and/or into a portion of the membrane 104, causing the plasma membrane 104 including its associated protein coat 105 to bulge and/or concave inwardly (as best shown in FIG. 3) to begin the formation of a portion of the membrane 104 having the solute T and the amphiphilic agent; that is, a vesicle 120 (see FIG. 4) begins to form. Referring now to FIG. 5 these is seen a partial plan view of the biological sample 100 after the subsequent release or “budding off” of the vesicle 120 into the cytoplasm 108. The vesicle 120 is coated with the protein 105 and contains the solute T and the amphiphilic agent. As exemplarily shown in FIG. 6, the vesicle 120 fuses with lysosome 112 to produce and/or form fused matter 124 which is also coated with the protein 105.

The internal, engulfed material within the fused matter 124 contains a reduced pH (e.g., a pH ranging from about 3.5 to about 6.0) due to ion pumps in the membrane. The acid hydrolases are activated by the low pH. The reduced pH of the internal, engulfed material causes the outer skin or membrane of the produced fused matter 124 to have an increased permeability which facilitates the leakage or passage of the solute (or any low molecular weight molecules) and the amphiphilic agent through the outer skin or membrane of the fused matter 124, as illustrated in FIG. 7. As previously indicated, when the solute is trehalose or any other low molecular weight molecule that is immune to the acidic engulfed material within the fused matter 124, trehalose escapes degradation due to the stability of its associated glycosidic linkage and freely passes intact through the increased-permeability membrane of the fused matter. As previously suggested, the remaining broken down components of the lysosome and the vesicle are released into the cytoplasm for further metabolism. Thus, the solute T and the amphiphilic agent are transferred out of the fused matter 124, as represented by arrow B in FIG. 7, when the permeability of the membrane of the fused matter 124 is increased, and when the engulfed material within the fused matter 124 breaks down or degrades for further metabolism within the cytoplasm. As previously indicated, the solute T and the amphiphilic agent preferably remain intact during the loading and/or solute transferring process and within the internal environment of the fused matter 124. Thus, the solute T and the amphiphilic agent remain essentially intact and whole when transferred out of the fused matter 124 and into the cytoplasm 108. The solute T and the amphiphilic agent survive conditions found in the lysosome-endosome and the intact solute T and the amphiphilic agent leak through the outer membrane of the fused matter 124 and into the cytoplasm. The biological sample 100 is now ready for further processing, such as drying, freezing, and subsequent rehydration, etc.

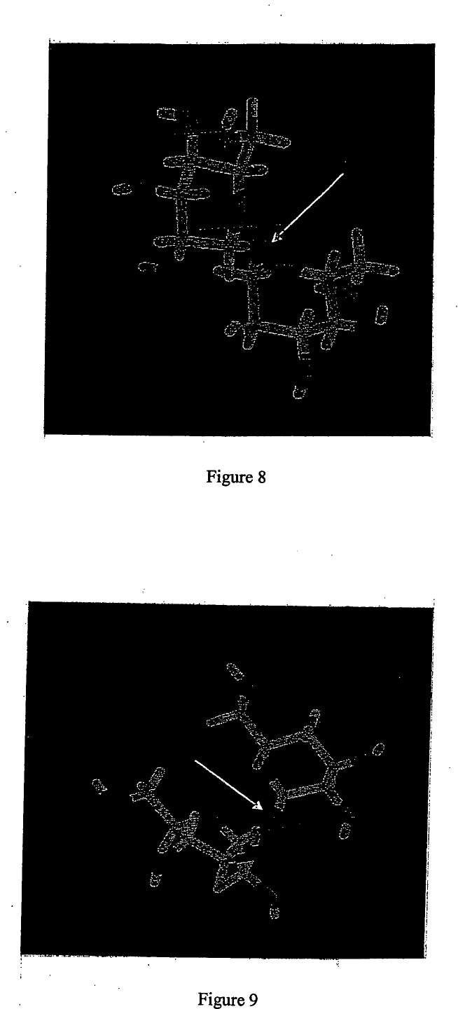

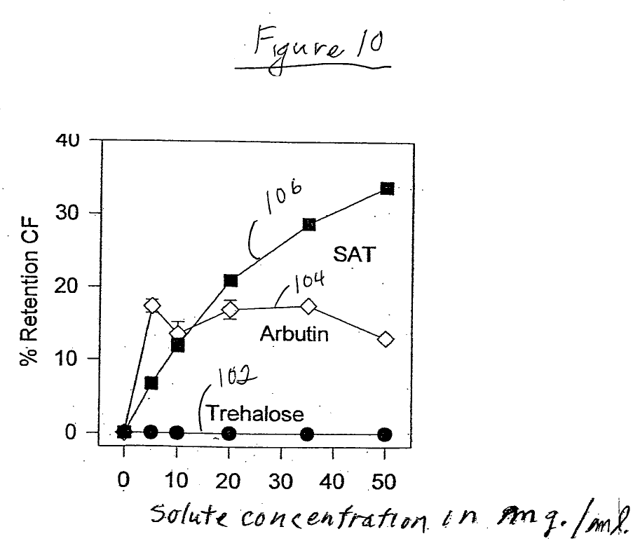

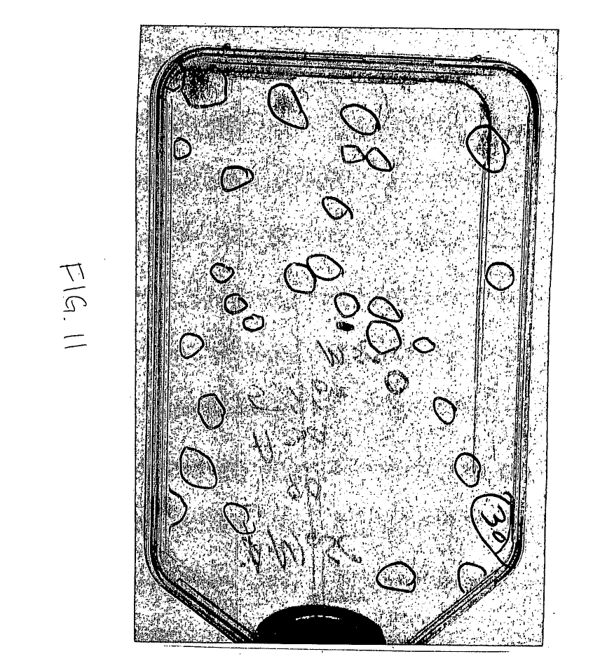

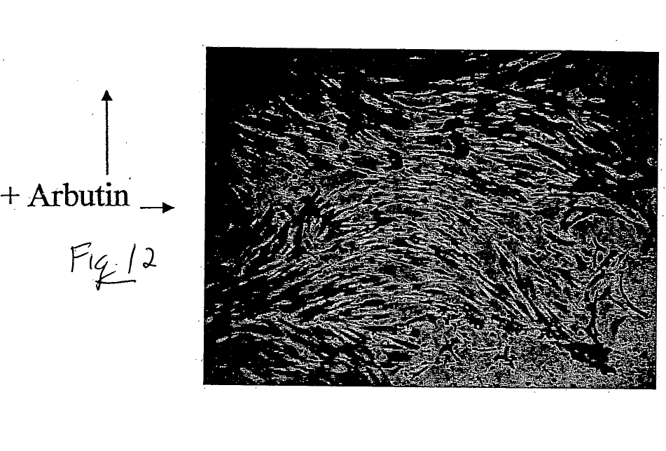

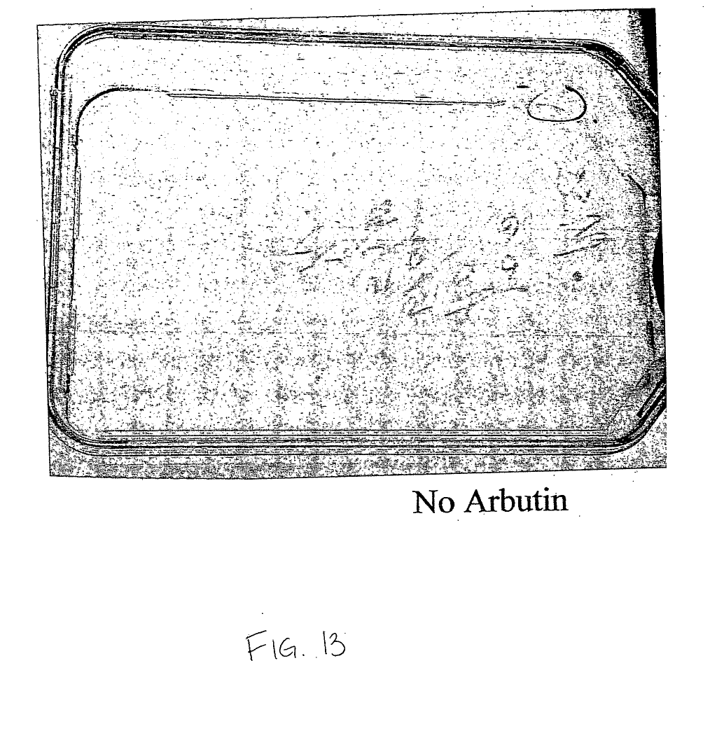

A preferred solute for embodiments of the present invention comprises trehalose. Most sugars degrade in fused lysosome-endosome due to the reduced pH and presence of acid hydrolases. Trehalose is the only non-reducing disaccharide of glusose. FIG. 8 is an enlarged chemical structural, chain formula diagram of trehalose, a non-reducing disaccharide of glucose, with an arrow pointing to a glycosidic bond. Severing of the glycosidic bond produces glucose which is ineffective in stabilizing dry biological materials. Sucrose, on the other hand, is a non-reducing disaccharide of glucose and fructose. FIG. 9 is an enlarged chemical structural, chain formula diagram of sucrose, a non-reducing disaccharide of glucose and fructose, with an arrow pointing to a glycosidic bond which is much more susceptible to hydrolysis than the glycosidic bond in trehalose. Trehalose survives conditions found in the lysosome-endosome and intact trehalose leaks into the cytosol of living cells.

Embodiments of the present invention will be illustrated by the following set forth examples which are being given to set forth the presently known best mode and by way of illustration only and not by way of any limitation. It is to be understood that all materials, chemical compositions and procedures referred to below, but not explained, are well documented in published literature and known to those artisans possessing skill in the art. All materials and chemical compositions whose source(s) are not stated below are readily available from commercial suppliers, who are also known to those artisans possessing skill in the art. All parameters such as concentrations, mixing proportions, temperatures, rates, compounds, etc., submitted in these examples are not to be construed to unduly limit the scope of the invention. Abbreviations used in the examples and/or in the foregoing discussion, if used, are as follows:
DMSO=dimethylsulfoxide
ADP=adenosine diphosphate
PGE1=prostaglandin El
HES=hydroxy ethyl starch
FTIR=Fourier transform infrared spectroscopy
EGTA=ethylene glycol-bis(2-aminoethyl ether)N,N,N′,N′,tetra-acetic acid
EDTA=ethylenediaminetetraacetic acid
TES=N-tris(hydroxymethyl)methyl-2-aminoethane-sulfonic acid
HEPES=N-(2-hydroxyl ethyl)piperarine-N′-(2-ethanesulfonic acid)
PBS=phosphate buffered saline
HSA=human serum albumin
BSA=bovine serum albumin
ACD=citric acid, citrate, and dextrose
MβCD=methyl-β-cyclodextrin
RH=relative humidity

### EXAMPLE 1

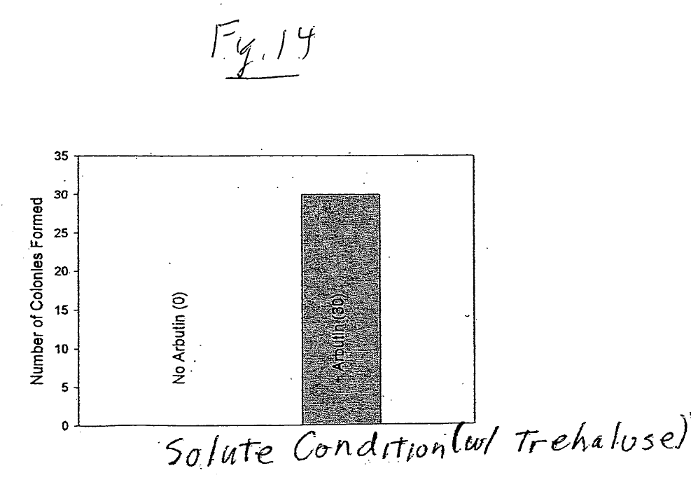

Liposomes were used as a model for biological membranes to determine if arbutin could provide a protective effect during drying. Extruded vesicles containing the fluorescent dye carboxyfluorescein (CF) were respectively air-dried in the presence of the following respective solute solutions: (i) 10 mM TES (pH 7.4), 0.1 mM EDTA, 50 mM NaCl, 3 mg/mL lipid, and trehalose at the concentrations stated in the FIG. 10; (ii) 10 mM TES (pH 7.4), 0.1 mM EDTA, 50 mM NaCl, 3 mg/mL lipid, and arbutin at the concentrations stated in the FIG. 10; and (iii) 10 mM TES (pH 7.4), 0.1 mM EDTA, 50 mM NaCl, 3 mg/mL lipid, and trehalose, sucrose, and arbutin in a 3:2:1 mass ratio at the total concentrations stated in the FIG. 10. Liposomes were composed of egg phosphatidylcholine/monogalactosyl diacylglycerol (60/40 w/w). Samples (10 μL) were air dried at 0% relative humidity in the presence of each of the solute solutions. CF retention was measured by fluorescence spectroscopy. The results are shown in FIG. 10 which are graphs of solute concentration vs. % retention CF for each of the solute solutions. More particularly, graph 102 is a graph for % retention of CF in the samples when air dried in the solute solution having trehalose in the designated solute concentration in mg./ml. Graph 104 is a graph for % retention of CF in the samples when air dried in the solute solution having arbutin in the designated concentration in mg./ml. Graph 106 is a graph for % retention of CF in the samples when air dried in the solute solution having SAT at a 3:2:1 mass ratio and in the designated solute concentration in mg./ml. It is clear that with a particular lipid combination, arbutin provides a protective effect to membrane integrity. The combination of arbutin with the disaccharides trehalose and sucrose was most effective in retaining CF, especially at a solute concentration greater than about 15 mg./ml.

### EXAMPLE 2

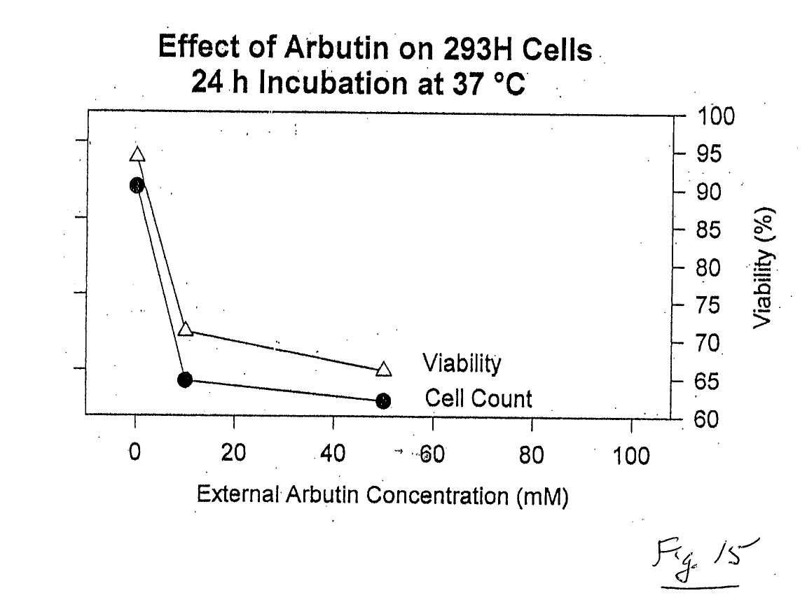

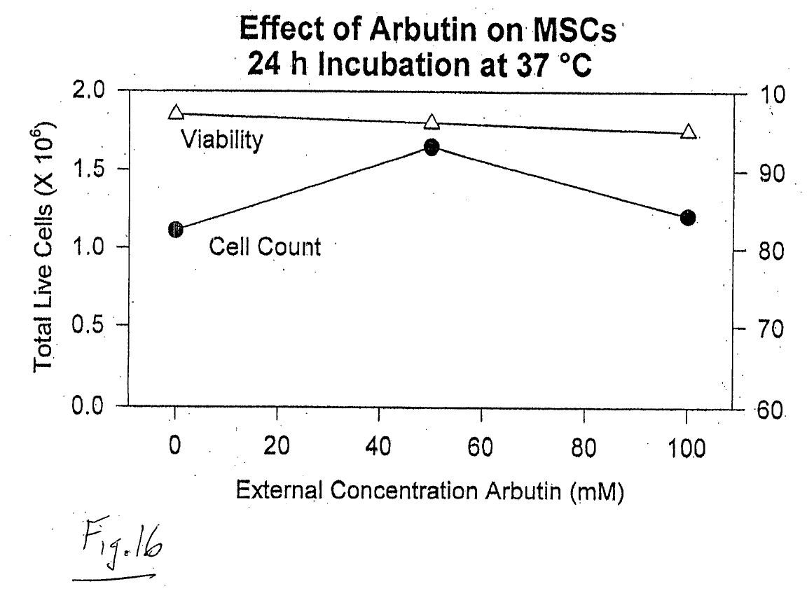

Human mesenchymal stem cells (MSCs) were respectively treated with a solute solution having arbutin and trehalose (i.e., Dulbecco's Modified Eagle's Medium (DMEM, Gibco cat #11885-046) containing 10% FBS, 80 mM trehalose and 30 mM arbutin), and with a solute solution having trehalose alone (i.e., Dulbecco's Modified Eagle's Medium (DMEM, Gibco cat #11885-046) containing 10% FBS and 100 mM trehalose) prior to lyophilization under the following loading conditions: 37° C., 5% CO₂, 90% RH, 24 h. The MSCs were also respectively lyophilized following loading with the solute solution having arbutin and trehalose (i.e., containing 10 mM HEPES (pH 7.2), 5 mM KCl, 100 mM NaCl, 150 mM trehalose, 75 mM arbutin, 5.7% BSA), and with the solute solution having trehalose alone (i.e., containing 10 mM HEPES (pH 7.2), 5 mM KCl, 140 mM NaCl, 150 mM trehalose, 5.7% BSA). The samples were incompletely freeze-dried to an average residual water content of 0.24 g H₂O/g dry weight, following which they were rehydrated with excess medium containing apoptosis inhibitor. The MSCs were stained with Commassie blue after growing for 3 weeks in culture. As illustrated in FIGS. 11, 12 and 13 only the sample dried with the solute solution having arbutin showed cellular attachment, growth, and colony formation (colonies are shown circled in FIG. 11). FIG. 13 is a picture of the MSCs which were lyophilized with the solute solution having trehalose and no arbutin. The cellular morphology in FIGS. 11 and 12 was normal and the colonies were healthy and robust.

### EXAMPLE 3

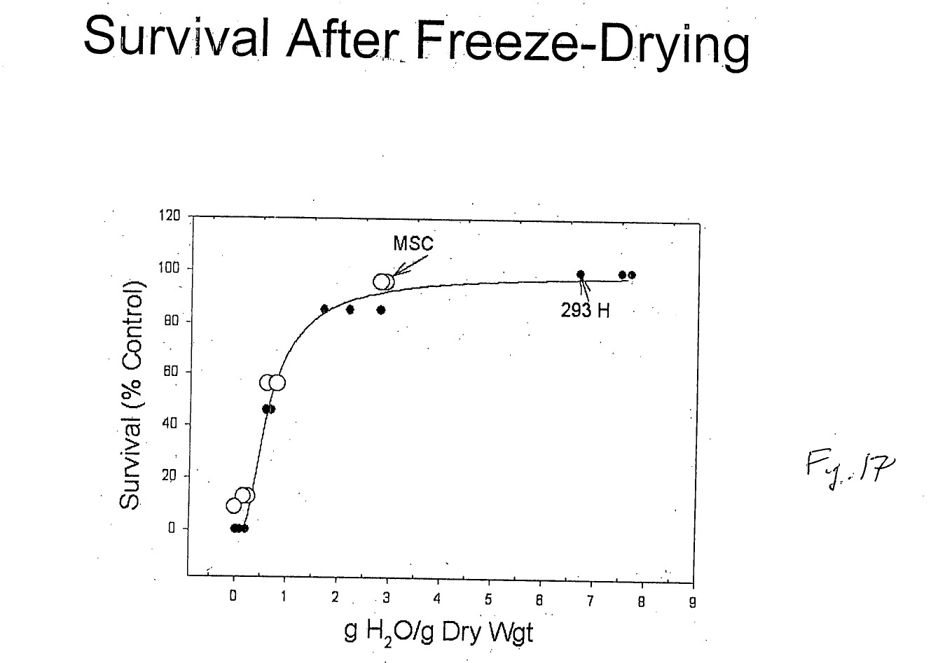

Colony formation following freeze-drying and rehydration was quantified by staining the samples the samples described in Example 2 with Co6 massie blue and counting the distinct colonies in each flask. Specifically, after loading and freeze drying to 0.24 g H₂O/g dry weight, as described in Example 2, and after rehydration with excess medium, as described in Example 2, the flasks were incubated at 37° C., 5% CO₂, and 90% RH for 3 weeks, in DMEM containing 10% FBS. For staining purposes, the medium was removed from each flask. The flasks were washed-twice with Dulbecco's phosphate buffered saline (DPBS, Gibco cat# 14190-144); and stained with Coomassie Brilliant Blue R250 (2% Coomassie blue, 50% methanol, 10% acetic acid in water) for 10 min. The samples were then washed with the destaining solution (5% methanol, 10% acetic acid in water) three times for 10 min each, and the flasks were examined by light microscopy. The total number of blue-stained colonies was counted in each flask. FIG. 14 illustrates the number of colonies formed versus samples with arbutin and without arbutin.

### EXAMPLE 4

Arbutin was tested for toxicity to 293H cells. In four flasks of 293H cells, the 293 medium (DMEM, Gibco cat #11965, with 10% FBS and 100 uM non-essential amino acids, Gibco# 11140) was removed and replaced with the same medium containing 0, 10, 50, or 100 mM arbutin. The cells were incubated at 37° C., 5% CO₂, and 90% RH for 24 h, after which they were harvested by trypsinization. Briefly, the medium was removed from the cultures and they were washed one time with 5 mL DPBS. Trypsin (1 mL of 0.05% in 0.53 mM EDTA-4Na) was added to the culture for ˜1 min and the flasks were rapped to dislodge the cells. Medium (4 mL) was added to stop the reaction, and the cells were pelleted by centrifugation at 176×g for 5 min. The pellet was resuspended in 1 mL DPBS. Cell counts and viability were assessed by trypan blue exclusion using five counts of 50-100 cells per 1 mm² hemocytometer grid square for each sample. The total number of live cells and the % viability of all cells are shown in FIG. 15. Both viability and cell number had decreased dramatically between 0 and 50 mM arbutin, and no live cells remained in the 100 mM arbutin sample. This shows that arbutin is toxic to some cell types, such as the 293H cells.

### EXAMPLE 5

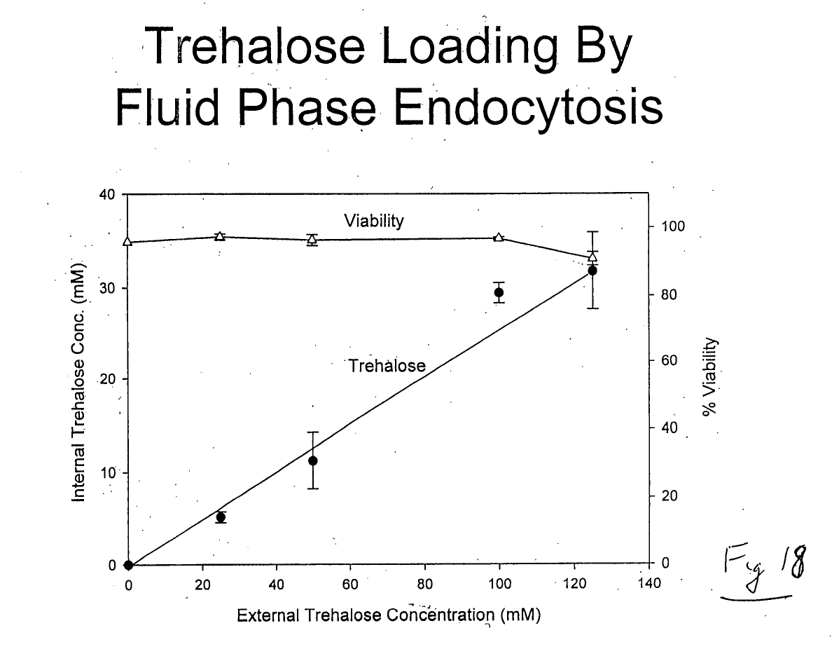

Arbutin was tested for toxicity to MSCs. In three flasks of MSCs, the MSC medium (Dulbecco's Modified Eagle's Medium, Gibco cat #11885-046) containing 10% FBS) was removed and replaced with the same medium containing 0, 50, or 100 mM arbutin. The cells were incubated at 37° C., 5% CO₂, and 90% RH for 24 h, after which they were harvested by trypsinization. Briefly, the medium was removed from the cultures and they were washed one time with 5 mL DPBS. Trypsin (1 mL of 0.05% in 0.53 mM EDTA-4Na) was added to the culture for ˜1 min and the flasks were rapped to dislodge the cells. Medium (4 mL) was added to stop the reaction, and the cells were pelleted by centrifugation at 176×g for 5 min. The pellet was resuspended in 1 mL DPBS. Cell counts and viability were assessed by trypan blue exclusion using five counts of 50-100 cells per 1 mm² hemocytometer grid square for each sample. The total number of live cells and the % viability of all cells are shown in FIG. 16. Both viability and cell number remained high between 0 and 100 mM arbutin. This shows that arbutin is not toxic to some cell types, such as the mesenchymal stem cells.

### EXAMPLE 6

MSCs and 293H cells were incubated in growth medium containing 100 mM trehalose for 24 h at 37° C., 5% CO₂, and 90% RH. The cells were harvested by trypsinization (as described in Example 5), and resuspended in freeze-drying buffer containing 10 mM HEPES (pH 7.2), 5 mM KCl, 140 mM NaCl, 5.7% BSA, and 150 mM trehalose. Aliquots (50 μL) were placed in Eppendorf microfuge tubes (without caps) and lyophilized on a Virtis Freezemobile freeze-dryer for various time points. The samples were rehydrated by the addition of water to a final volume of 50 μL. Viability was measured by trypan blue exclusion, as described in Example 5, and water content was measured by gravimetric analysis on separate samples. Briefly, samples used for water content analysis were weighed after removal from the freeze-dryer. They were then heated to 80° C. for 24 h to remove the residual water and re-weighed. These measurements provided the weight of the water and the dry weight of the samples after the tare weight of the tubes were subtracted. The water contents are reported in FIG. 17 as g H₂O/g dry weight, and viabilities are reported as the percent of the undried controls.

### EXAMPLE 7

Trehalose uptake in MSCs was measured as a function of extracellular trehalose concentration. For these experiments, MSCs were grown in MSC medium to 90-95% confluence. For the concentration series, cells were incubated at 37° C. for 24 hours in MSC growth medium with the addition of 0, 25, 50, 100, or 125 mM trehalose. Following incubation, the cells were washed once with 10 mL DPBS, and harvested by trypsinization, as described above. The cells were then washed an additional three times with 10 mL DPBS each and collected by centrifugation (167×g). The pellet was resuspended in 1 mL DPBS. Viability was assessed by trypan blue exclusion using five counts of 50-100 cells per 1 mm² hemocytometer grid square for each sample. The cells were extracted by incubating in 80% methanol at 80° C. for one hour. The trehalose enters the supernatant, which was collected after centrifuging the suspension at 200×g for 10 min. The supernatant was evaporated under a stream of N₂ at 40° C., and the dry residue dissolved in 3 mL nano-pure water. For trehalose quantitation, the anthrone reaction was used. Briefly, the samples (3 mL) were mixed with 6 mL anthrone reagent (2% anthrone (Sigma-Aldrich) in sulfuric acid), heated to 100° C. for 3 min, and allowed to cool. Absorbance at 620 nm was read on an Amersham-Pharmacia Biotech Ultrospec 3300 pro spectrophotometer at room temperature and compared to a standard curve. In control experiments, the last wash solution was assayed for residual trehalose. The resulting anthrone absorbance was negligible and fell within the range of experimental error for control samples containing DPBS buffer only without sugar. As the anthrone method detects all sugars, unloaded control cells were always treated in parallel. These values, normalized for cell count, were subtracted from the trehalose-loaded samples in order to evaluate trehalose specifically and to avoid artifact due to endogenous sugars. Data are shown in FIG. 18 for three independent measurements. The finding that trehalose uptake is linearly dependent on the extracellular trehalose concentration suggests that fluid phase endocytosis is the mechanism of trehalose uptake. The finding that viability is high at all trehalose concentrations indicates that the sugar is not toxic to the cells under these conditions.

### EXAMPLE 8

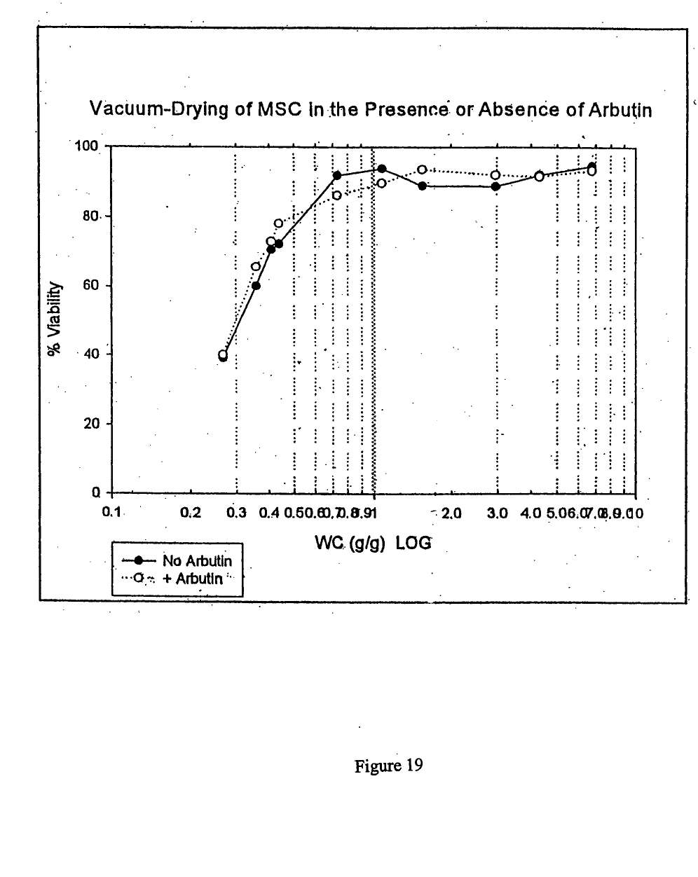

Human mesenchymal stem cells (MSCs) were loaded with trehalose and arbutin by incubating the cells in growth medium containing 100 mM trehalose and 30 mM arbutin for 24 h at 37° C. Alternatively, MSCs were loaded with trehalose only by incubating them in medium containing 100 mM trehalose. The cells were then transferred to air-drying buffer containing 10 mM HEPES (pH 7.2), 5 mM KCl, 65 mM NaCl, 150 mM trehalose, and 5.7% BSA with or without the addition of 70 mM arbutin, and with or without the addition of 70 mM arbutin. The cellular suspensions were aliquotted into 50-uL droplets in the caps of Eppendorf microcentrifuge tubes. The samples were vacuum-dried by enclosing them in a sealed chamber subjected to a vacuum of approximately 3 in Hg for 2-3 h. Samples were removed at various time points and tested for viability by propidium iodide exclusion and water content by gravimetric analysis. When viability immediately following rehydration was graphed as a function of residual water content, FIG. 19 was obtained. Note that the viabilities at each water content are extremely similar for the arbutin-containing samples and controls. This indicates that although arbutin does not show an immediate benefit following rehydration, it also does not interfere with viability as we have seen with other antioxidants tested.

### EXAMPLE 9

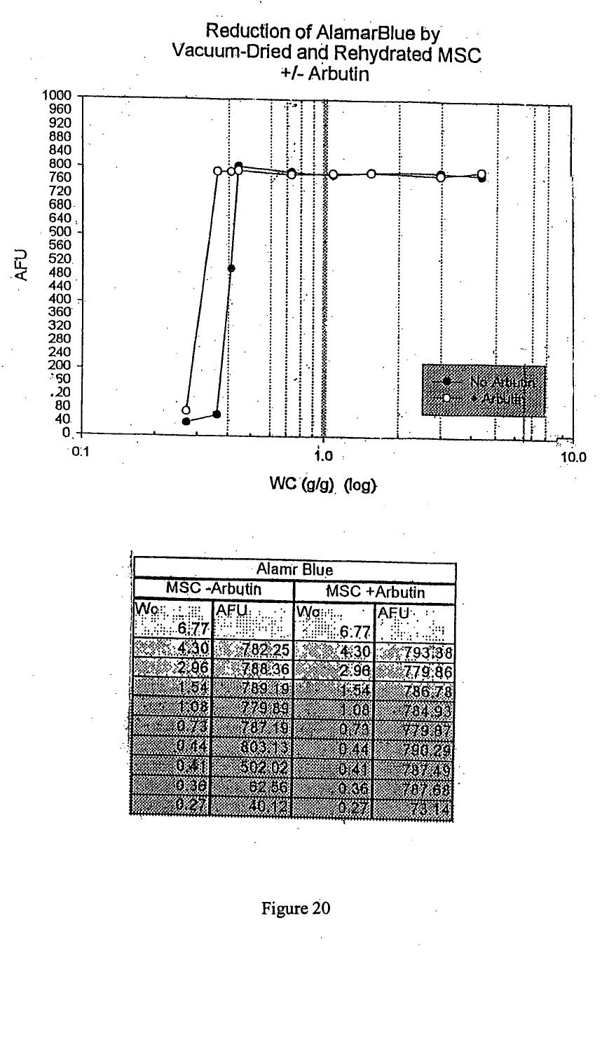

MSCs were loaded with trehalose only or trehalose and arbutin and vacuum-dried in air-drying buffer containing trehalose only or trehalose and arbutin as described above. Samples were removed at various time points, and rehydrated with excess medium. The rehydrated samples were plated with fresh medium containing 10% alamarBlue and incubated at 37° C. for 24 h. The reduction of alamarBlue was then quantitated by measuring the fluorescence (Ex 530, Em 585) on a Perkin Elmer fluorescence spectrophotometer. AlamarBlue is a metabolism sensitive dye that is reduced by metabolic by-products in the medium. Therefore, the higher the fluorescence, the more actively metabolizing cells are present in the sample. FIG. 20 shows the fluorescence of alamarBlue as a function of the water content to which the cells were dried. At the higher water contents, there is no difference between the reduction of alamarBlue in the arbutin-containing samples compared to that of the controls. However, the fluorescence in the control samples decreases precipitously in the range of 0.4 g H₂O/g dry weight. However, the arbutin-containing samples do not show the same decrease until they reach 0.27 g H₂O/g dry weight. This indicates that arbutin provides some protective effect to the dried cells that appears over time in the growing rehydrated samples.

### EXAMPLE 10

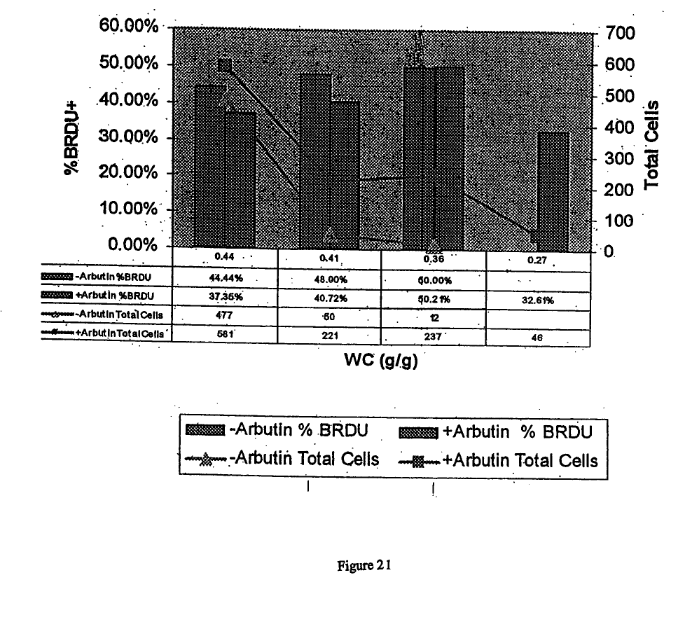

MSCs were loaded with trehalose only or trehalose and arbutin and vacuum-dried in air-drying buffer containing trehalose only or trehalose and arbutin as described above. Samples were removed at various time points, and rehydrated with excess medium. The rehydrated samples were plated with fresh medium containing BrdU. BrdU is only incorporated into newly synthesized DNA, and thus can be used as a marker for cell division. The rehydrated samples were grown in the BrdU-containing medium for 4 days, after which they were washed extensively and stained with fluorescent antibodies to BrdU. The samples were mounted on slides and observed microscopically. Differential interference contrast microscopy was used to count the total number of cells (in four separate fields of view), and fluorescence microscopy was used to count the number of cells that stained for BrdU (in the same cell population). FIG. 21 shows line plots indicating the total number of cells in each sample (squares for arbutin-containing samples, and triangles for controls), and a histogram indicating the percentage of those cells that were positively stained for BrdU. Although the total number of cells decreased as the water content decreased for both conditions, the cell number decreased much more rapidly in the control samples than in the arbutin-containing samples. The histogram shows that at 0.36 g H₂O/g dry weight and above, the percentage of cells staining for BrdU was similar between the two conditions. However, at the lowest water content tested (0.27 g H₂O/g dry weight), only the arbutin-containing samples contained BrdU positive cells, because only in the arbutin-containing samples were there any cells present. This result indicates that the arbutin containing samples had a large advantage in cell survival and cell division compared to the samples containing only trehalose.

### CONCLUSION

Embodiments of the present invention provide that arbutin and trehalose, a sugar found at high concentrations in organisms that normally survive dehydration, may be used to protect biological samples during drying and rehydration. Arbutin aids survival and recovery of dehydrated biological samples, such as lyophilized human cells. Arbutin is a compound found in plants that can survive prolonged periods of drought. Embodiments of the present invention also provide treating a biological material with arbutin, sucrose and trehalose.

Mesenchymal stem cells (MSCs) were treated with arbutin prior to and during incomplete lyophilization (to an average residual water content of about 0.24 g H₂O/g dry weight) Following rehydration with excess medium, the cells treated with arbutin showed attachment and growth.

The beneficial effects of arbutin in helping biological samples survive the stresses of drying and rehydration has been provided. The protective effect of arbutin emerges over time after rehydration during the growth phase of the cells.

While the present invention has been described herein with reference to particular embodiments thereof, a latitude of modification, various changes and substitutions are intended in the foregoing disclosure, and it will be appreciated that in some instances some features of the invention will be employed without a corresponding use of other features without departing from the scope and spirit of the invention as set forth. Therefore, many modifications may be made to adapt a particular situation or material to the teachings of the invention without departing from the essential scope and spirit of the present invention. It is intended that the invention not be limited to the particular embodiment disclosed as the best mode contemplated for carrying out this invention, but that the invention will include all embodiments and equivalents falling within the scope of the appended claims.

1. A method for stabilizing a biological material comprising treating a biological material with an amphiphilic agent to stabilize the biological material.

2. The method of claim 1 additionally comprising dehydrating the biological material.

3. The method of claim 1 wherein said amphiphilic agent comprises an amphiphilic compound.

4. The method of claim 3 wherein said amphiphilic compound comprises arbutin.

5. A method for protecting a biological material comprising:
disposing a biological material in a solution having an amphiphilic agent for transferring the amphiphilic agent from the solution into the biological material for protecting the biological material.

6. The method of claim 5 wherein said amphiphilic agent comprises an amphiphilic compound.

7. The method of claim 6 wherein said amphiphilic compound comprises arbutin.

8. The method of claim 5 wherein said biological material is selected from the group consisting of blood platelets and cells.

9. The method of claim 5 wherein said solution additionally comprises a carbohydrate.

10. The method of claim 5 wherein said solution additionally comprises an oligosaccharide.

11. The method of claim 10 wherein said oligosaccharide comprises at least one disaccharide.

12. The method of claim 11 wherein said disaccharide is selected from the group consisting of trehalose, sucrose, and mixtures thereof.

13. A biological material produced in accordance with the method of claim 1.

14. A biological material produced in accordance with the method of claim 5.

15. A solution for treating a biological material comprising an amphiphilic agent and a carbohydrate.

16. The solution of claim 15 comprising from about 1.0% by wt. to about 40% by weight of the carbohydrate, and from about 0.01 to about 40% by weight of the amphiphilic agent.

17. The solution of claim 15 comprising from about 2.0% by wt. to about 12% by weight of the carbohydrate, and from about 0.1 to about 20% by weight of the amphiphilic agent.

18. The solution of claim 15 comprising from about 4.0% by wt. to about 8% by weight of the carbohydrate, and from about 0.50 to about 10% by weight of the amphiphilic agent.

19. The solution of claim 15 wherein said carbohydrate comprises a disaccharide.

20. The solution of claim 19 wherein said disaccharide comprises trehalose.

21. The solution of claim 15 wherein said amphiphilic agent comprises arbutin.

22. The solution of claim 15 comprising from about 0.01% by wt. to about 60% by weight of the carbohydrate, and from about 0.01 to about 30% by weight of the amphiphilic agent.

23. The solution of claim 15 comprising from about 0.02% by wt. to about 40% by weight of the carbohydrate, and from about 0.01 to about 20% by weight of the amphiphilic agent.

24. The solution of claim 15 comprising from about 0.20% by wt. to about 20% by weight of the carbohydrate, and from about 0.10 to about 10% by weight of the amphiphilic agent.

25. The solution of claim 15 comprising from about 1.5% by wt. to about 6% by weight of the carbohydrate, and from about 1 to about 5% by weight of the amphiphilic agent.

26. A process for loading a biological sample comprising
loading a biological sample with a solute and an amphiphilic agent by fluid phase endocytosis to produce an internally loaded biological sample.

27. The process of claim 27 wherein said loading a biological sample by fluid phase endocytosis comprises fusing within the biological sample a first matter with a second matter to produce a fused matter.

28. The process of claim 27 wherein said first matter comprises the solute and the amphiphilic agent.

29. The process of claim 27 wherein said first matter comprises a vesicle having the solute and the amphiphilic agent.

30. The process of claim 27 wherein said second matter comprises a lysosome.

31. The process of claim 29 wherein said second matter comprises a lysosome.

32. The process of claim 27 wherein said fused matter comprises the solute and the amphiphilic agent.

33. The process of claim 31 wherein said fused matter comprises the solute and the amphiphilic agent.

34. The process of claim 27 wherein said loading a biological sample by fluid phase endocytosis additionally comprises transferring the solute and the amphiphilic agent from the fused matter within the biological sample.

35. The process of claim 33 wherein said loading a biological sample by fluid phase endocytosis additionally comprises transferring the solute and the amphiphilic agent from the fused matter within the biological sample.

36. The process of claim 34 wherein the solute and the amphiphilic agent are transferred from the fused matter into a cytoplasm within the biological sample.

37. The process of claim 35 wherein the solute and the amphiphilic agent are transferred from the fused matter into a cytoplasm within the biological sample.

38. The process of claim 27 wherein said fused matter comprises a lower pH than a pH of the first matter.

39. The process of claim 37 wherein said fused matter comprises a lower pH than a pH of the first matter.

40. The process of claim 27 wherein said fused matter comprises a pH of less than about 6.5.

41. The process of claim 26 wherein said biological sample includes a biological sample selected from a group of biological samples comprising a platelet and a cell.

42. The process of claim 26 wherein said solute is selected from a group of carbohydrates consisting of trehalose, sucrose, and mixtures thereof.

43. A biological sample produced in accordance with the process of claim 26.
